(19) United States
(12) Patent Application Publication
(10) Pub. No.: US 2003/0221631 A1
(43) Pub. Date: Dec. 4, 2003

(54) Automated pet door system

(76) Inventor: Charles J. Yarbrough, Claremont, CA (US)

Correspondence Address: CHARLES J. YARBROUGH, 4221 Lynoak Drive, Claremont, CA, 91711, US

(21) Appl. No.: 10/160,918

(22) Filed: Jun. 3, 2002

(51) Int. Cl. A01K 1/03; A01K 1/035; E06B 7/28

(52) U.S. Cl. 119/484

(57) ABSTRACT

A device to be used for the control of animals, which has a latching feature to prevent their passage during certain periods of time. The latching element is comprised of a mechanism activated by a timing device. When the mechanism is activated by the timing device, a latch is retracted, allowing a self closing door to open by swinging in either direction. When the mechanism is not activated by the timing device, the latch is extended and prevents the door from opening, or swinging, in one direction, while allowing it to open in the other direction.

### FIELD OF THE INVENTION

This invention relates to door systems. In particular, this invention relates an automated pet door system for controlling the entrance and exit of house pets or other domesticated animals.

### BACKGROUND OF THE INVENTION

Doors or gates that allow free passage of animals are well known in the prior art. Traditionally, pet doors have been built into standard house doors where a small swinging pet door is located in the bottom half of the door. Pet doors allow pets, such as cats and dogs, to travel in and out of the house without having the owner of the pets to open and close the door for them. However, existing pet doors have no means to actually control the access of pets. Either the owner has to leave the pet door open or locked manually. There is no control mechanism to keep the pet indoors without the direct effort of the owner. Other types of gates or doors for the passage of animals also have the same problem.

However, in parts of the country where homes are built close to the habitats of wild animals, a particular problem has occurred where wild animals, such as coyotes, have attacked and killed household pets in the backyards of these homes. Although homeowners have been able to protect their pets by keeping them indoors, many homeowners would like to be able to allow their pets to roam free in their backyard or surrounding wilderness area, without their constant supervision or control. However, the use of traditional pet doors has caused the problem where pets would go out in the middle of the night and be found missing or killed the next morning. Although prior art pet doors often had a simple bolt lock located to lock the pet door at night, often owners would forget to either lock the pet door or forget to open it in the morning to allow the pets to roam freely during the day. In addition, when the owner is on vacation or otherwise occupied, pets or other domesticated animals may roam free under less than desirable conditions. Lastly, existing pet doors do not solve the problem of having to constantly monitor the animal's location to know whether to lock or unlock the pet door. This problem is enhanced if the pet door is located in a distant location from the house.

Therefore, there is a need in the prior art for an improved pet door for better protecting household pets, while allowing freedom for the pet to roam during times when the risk of predatory animals are low.

### SUMMARY OF THE DISCLOSURE

An automated pet door system wherein a pet door is built into a door of a house, the automated pet door system comprising a pet door able to swing along an arch pathway from a pivot access point, a latching mechanism to control whether the door can swing freely or limit the door to swing in one direction, and a controller to control the latching mechanism. In preferred embodiments, the latching mechanism comprises a plunger that extends and retracts to either limit the swing of the door or allow the door to swing freely and a solenoid for automatically controlling the movement of the plunger. In further embodiments, the controller is a timing device working in conjunction with a power source such that the timing device shuts off the power source to the solenoid causing a spring to extend the plunger, and turns on the power source to the solenoid causing the plunger to retract.

Other features and advantages of the invention will become apparent from the following detailed description, taken in conjunction with the accompanying drawings which illustrate, by way of example, various features of embodiments of the invention.

### BRIEF DESCRIPTION OF THE DRAWINGS

A detailed description of embodiments of the invention will be made with reference to the accompanying drawings, wherein like numerals designate corresponding parts in the several figures.

FIG. 1 illustrates the environment of the pet door apparatus in accordance with an embodiment of the present invention.

FIG. 2 is a cross-sectional view illustrating the locked position of the pet door system in accordance with an embodiment of the present invention;

FIG. 3 is another cross-sectional view illustrating the unlocked position of the pet door system in accordance with an embodiment of the present invention; and

FIG. 4 is block diagram of the locking mechanism in accordance with an embodiment of the present invention.

### DETAILED DESCRIPTION OF THE PREFERRED EMBODIMENTS

In accordance with the embodiments of the present invention, an automated pet door system is provided which alleviate many of the problems of the prior art. Since predatory animals tend to come out during the night, in preferred embodiments, the pet door system would be automatically latched during afternoon/evening hours to allow animals to pass through the pet door in only one direction. By placing the animal's food, water supply, or other inducements on the desired side of the door or gate, the animal would pass through the pet door to come inside the house or yard, but not be able to leave until the automated pet door system unlatches the pet door. Therefore, typically by dark, the pet would have entered for food or water and be prevented from exiting. In the morning, the automated door would be automatically unlatched and the pet could enter or exit at will until the next afternoon when the pet door would be latched again.

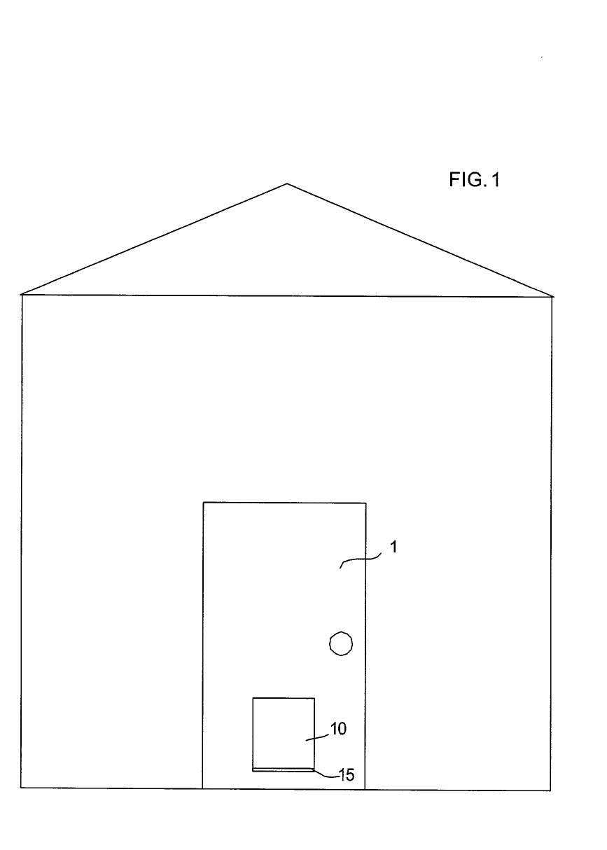

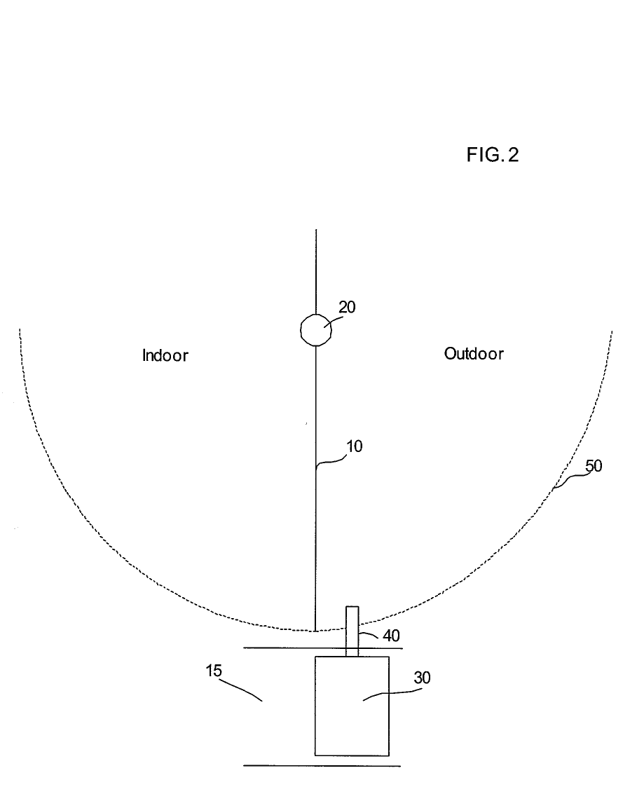

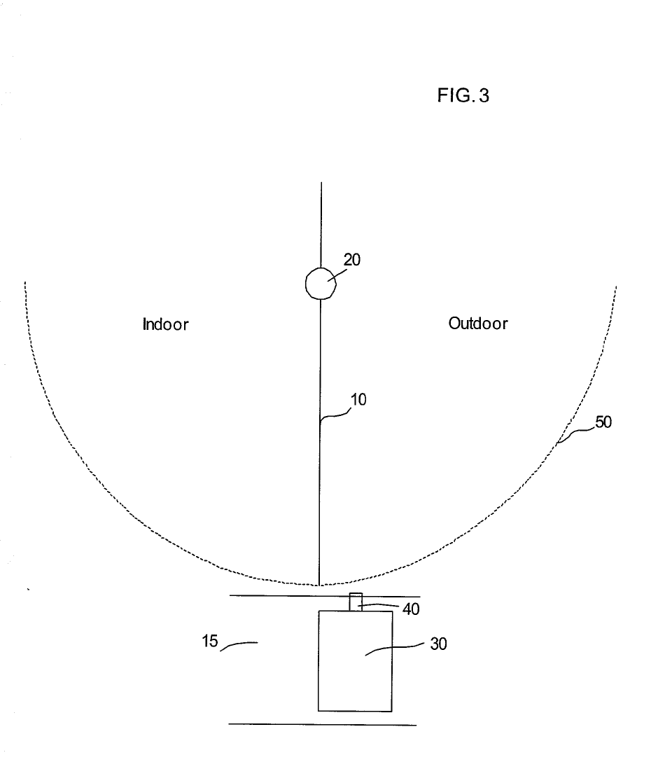

FIG. 1 illustrates the environment of the pet door system in accordance with an embodiment of the present invention. As in the prior art, the frame of a pet door 10 is often built into and/or cut out of a house door 1. The pet door 10 is large enough for pet to travel in and out of the house, but too small to allow humans to travel through the pet door 10. Typically, the pet door 10 is connected to the house door 1 by means of hinge 20 (or other similar device allowing the pet door to move about a pivot axis point) located on top of the pet door 10. As a pet pushes the pet door 10 to exit the house, the pet door 10 swings open while the pet exits (according to the arch pathway 50 in FIGS. 2 and 3), and swings close by the work of gravity. Similarly, when the pet wants to reenter the house, the pet can push the pet door 10 in the opposite direction and the pet door will swing open again in the opposite direction (according to the arch pathway 50 in FIGS. 2 and 3) to allow the pet to come back indoors.

Again the pet door 10 will swing back shut by the work of gravity. In preferred embodiments, the pet door 10 is accompanied by a doorjamb 15. The doorjamb 15 is mounted opposite the bottom edge of the pet door 10 on the door 1, as seen in FIG. 1. The doorjamb 15 serves to minimize abrasive contact to the pet as the pet travels through the pet door 10, and strengthen the overall structure of the pet door frame and the door 1. Similarly, rounded or cushioned side walls (not shown) can be placed on the side frames of the pet door to both provide smoother passage for the pets and/or structural support. Although the pet door 10 has been shown built into a house door 1, in alternative embodiments, the pet door 10 can also be built into other locations besides a house door 1, such as a gate, wall, or fence surrounding the backyard or corral. In addition, the pet door or gate may alternatively pivot about a vertical axis. In the event that the door or gate pivots about a vertical axis, the door must be arranged such that it returns to a closed position of its own accord, such as a double-sided spring mechanism that causes the door to restore to the closed position.

FIGS. 2 and 3 illustrate the locked and unlocked position of the pet door system in accordance with an embodiment of the present invention. In the preferred embodiments, the locking mechanism to prevent the pet door 10 from swinging open freely is comprised of a plunger 40 in combination with a solenoid 30. By placing the plunger 40 on one side of the pet door 10, the plunger is able to prevent the pet door 10 from swinging open in one direction. As seen in FIG. 2, the plunger 40 in the extended position prevents the pet door 10 from swinging in the counter clockwise direction along the arch pathway 50. When the plunger 40 is retracted as seen in FIG. 3, the pet door 10 is free to swing open in both directions about the pivot axis 20.

In the preferred embodiments, a solenoid 30 acts a plunger control mechanism to extend or retract the plunger 40. Typically, the solenoid 30 is comprised of a coil of wire that produces a magnetic field when electricity to applied to the coil. The magnetic field pulls the plunger 40 into the coil, compressing a spring. Once the power is disconnected, the spring acts to return the plunger 40 to its original position. Thus, the plunger 40 of the inactivated solenoid 30 is in the extended (i.e. closed) position, while when the solenoid 30 is activated the plunger 40 is in the retracted (open) position, as seen in FIG. 3.

In the preferred embodiments, the solenoid 30 is mounted on or installed inside the doorjamb 15 so that when the plunger 40 is in the retracted position, the pet door 10 is able to clear both the solenoid 30 and the retracted plunger 40, either because the solenoid 30 is completely inside the doorjamb 15 or is small enough to be mounted on the top or side of the doorjamb 15. Alternatively, the solenoid 30 can be built into or mounted on the door of the house or on the pet door 10 itself or anywhere along the frame of the pet door 10.

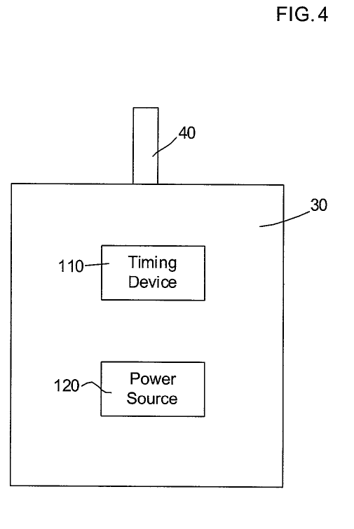

FIG. 4 is block diagram of the locking mechanism in accordance with an embodiment of the present invention. As described above, the preferred embodiments of the locking mechanism is comprised of the plunger 40 in combination with the solenoid 30. In addition, in the preferred embodiments, the locking mechanism also comprises a timing device 110 and a power source 120. The timing device 110 is used in conjunction with the power source 120 to activate the solenoid 30 during hours when the pet door 10 would be open in both directions, and turn off the solenoid during hours when the pet door 10 should be open in only one direction. The homeowner has the option to program the timing device 110 to set the hours when the pet door should be restricted. When the shutoff time set by the user is recognized by the timing device 110, the power source 120 is cut off, releasing the plunger 40 into its extended position. Similarly, when the opening time set by the user is recognized by the timing device 110, electricity from the power source is delivered to the solenoid, causing the plunger 40 to retract.

The timing device 110 can be any known timer in the prior art. The timing device 110 can made from any known electronic circuits or be mechanical in nature. The timing device 110 can be manufactured as a part of the power source 120, or be built as separate elements. Similarly, the power source 120 can be self-contained batteries located within the solenoid 30 or have a connection to a traditional AC wall outlet to receive commercially supplied electricity.

Alternative Embodiments

Other alternative embodiments of this device are also included in the invention. For example, by employing two of these locking devices, one on each side of the door, it is possible to completely control the anirnal's exit or entry. In addition, although the latching mechanism was preferably described as a solenoid in combination with a mechanical plunger, a non electric switching device may also be employed. For example, a hand turned spring powered mechanical timer may be used to activate a mechanical plunger.

Similarly, although preferred embodiments described a latching mechanism that unlocked when a timer reached a set time, in alternative embodiments, the timer can lock the door rather than unlock it. In other words, energizing the solenoid operates a mechanism that causes the door to lock instead of unlock. Moreover, although the preferred embodiment described building the locking mechanism either into or mounted on top of the doorjamb, the latch may be attached directly to the door itself or anywhere along the frame of the pet door.

In addition, although the preferred embodiments are described in the context of controlling the movement of household pets from the house using a pet door, the present invention can be used in other applications for allowing/prohibiting access of other type of animals or people.

Therefore, while the description above refers to particular embodiments of the present invention, it will be understood that many modifications may be made without departing from the spirit thereof. The accompanying claims are intended to cover such modifications as would fall within the true scope and spirit of the present invention. The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. An automated door system comprising:
a door able to swing along an arch pathway from a pivot axis point;
a latching mechanism to control whether the door can swing freely or limit the door to swing in one direction; and
a controller to control the latching mechanism.

2. The automated door system of claim 1, wherein the latching mechanism comprises:
a plunger that extends and retracts to either limit the swing of the door or allow the door to swing freely; and
a solenoid for automatically controlling the movement of the plunger.

3. The automated door system of claim 1, wherein the controller is a timing device working in conjunction with a power source.

4. The automated door system of claim 2, wherein the controller is a timing device working in conjunction with a power source such that the timing device shuts off the power source to the solenoid causing a spring to extend the plunger, and turns on the power source to the solenoid causing the plunger to retract.

5. The automated door system of claim 3, wherein the power source is a battery or commercially supplied electricity.

6. The automated door system of claim 1, wherein the door is a gate.

7. The automated door system of claim 1, wherein the latching mechanism is built into a doorjamb.

8. The automated door system of claim 1, wherein the latching mechanism is mounted on top or a side of a doorjamb.

9. The automated door system of claim 1, wherein the latching mechanism is mounted on the door.

10. The automated door system of claim 1, wherein the door is a pet door built into a door of a house.

11. The automated door system of claim 1, wherein the door is a pet door built into a barn door.

12. The automated door system of claim 1, wherein the door is a pet door built into a corral fence.

13. An automated pet door system wherein a pet door is built into a door of a house, the automated pet door system comprising:
a pet door able to swing along an arch pathway from a pivot axis point;
an automatic latching mechanism to control whether the pet door can swing freely or limit the pet door to swing in one direction; and
a controller to control the latching mechanism.

14. The automated pet door system of claim 13, wherein the latching mechanism comprises:
a plunger that extends and retracts to either limit the swing of the pet door or allow the pet door to swing freely; and
a solenoid for automatically controlling the movement of the plunger.

15. The automated pet door system of claim 13, wherein the controller is a timing device working in conjunction with a power source.

16. The automated pet door system of claim 14, wherein the controller is a timing device working in conjunction with a power source such that the timing device shuts off the power source to the solenoid causing a spring to extend the plunger, and turns on the power source to the solenoid causing the plunger to retract.

17. The automated pet door system of claim 15, wherein the power source is a battery or commercially supplied electricity.

18. The automated pet door system of claim 13, wherein the latching mechanism is built into a doorjamb.

19. The automated pet door system of claim 13, wherein the latching mechanism is mounted on top or a side of a doorjamb.

20. The automated pet door system of claim 13, wherein the latching mechanism is mounted on the pet door.
